(19) United States
(12) Patent Application Publication
(10) Pub. No.: US 2013/0114896 A1
(43) Pub. Date: May 9, 2013

(54) IMAGE PROCESSING APPARATUS, IMAGE PROCESSING METHOD AND PROGRAM

(71) Applicant: Sony Corporation, Tokyo (JP)

(72) Inventors: Jun Matsumoto, Kanagawa (JP); Hiroaki Ebi, Tokyo (JP); Yoshimi Tsuboi, Tokyo (JP)

(73) Assignee: Sony Corporation, Tokyo (JP)

(21) Appl. No.: 13/667,255

(22) Filed: Nov. 2, 2012

(30) Foreign Application Priority Data
Nov. 8, 2011 (JP) 2011-244704

(51) Int. Cl. G06K 9/40

(52) U.S. Cl. 382/167

(57) ABSTRACT

An image processing apparatus includes: a color discrimination section configured to discriminate a color of each pixel of an input image; a boundary region setting section configured to set a boundary region of a predetermined color based on a result of the color discrimination in the color discrimination section; and a noise removing section configured to control a noise removing characteristic based on a result of the boundary region setting in the boundary region setting section to remove noise from the input image.

### BACKGROUND

The present technology relates to an image processing apparatus and an image processing method. Particularly, the present technology relates to an image processing apparatus and an image processing method adapted to suppress color fringing in noise removal of an image.

Normally, image processing apparatuses remove noise by, for example, smoothing using a filter such as an averaging filter and a Gaussian filter or by a process using an order statistics filter such as a median filter. When a smoothing filter or an order statistics filter is used, it is difficult to remove noise over a wide range (low-frequency noise). Therefore, as disclosed in Japanese Patent Laid-Open No. 2010-157163, the input image is reduced before filtering so that noise over a wide range can be removed. Further, in order to prevent resolution degradation in noise removal, as disclosed in Japanese Patent Laid-Open No. 2010-213086, the mixture rate of the original image is increased only in specific color portions in order to lower the effect of noise removal.

### SUMMARY

Incidentally, when removing noise from an input image, color fringing on an edge of the input image sometimes becomes more likely to be perceived. For example, it is possible to remove noise over a wide range by reducing the input image before filtering, but in the enlargement of the reduced image, color fringing sometimes becomes likely to be perceived on a boundary between a red-based color region and a low-luminance region or an achromatic color region. Further, even when noise is removed without reducing the size of the input image, there is a possibility that color fringing becomes likely to be perceived on a boundary portion by removing noise over a wide range.

Therefore, it is desirable to provide an image processing apparatus, an image processing method and a program by which color fringing in noise removal can be suppressed.

One embodiment of the present technology is an image processing apparatus, including:

a color discrimination section configured to discriminate a color of each pixel of an input image;

a boundary region setting section configured to set a boundary region of a predetermined color based on a result of the color discrimination in the color discrimination section; and

a noise removing section configured to control a noise removing characteristic based on a result of the boundary region setting in the boundary region setting section to remove noise from the input image.

In this embodiment, color discrimination of each pixel of an input image is carried out, and a boundary region of a color in which color fringing in noise removal is likely to be perceived is set. The noise removing characteristic is controlled based on the result of the boundary region setting and, for example, in the boundary region, a smoothing process in which a smoothing unit is narrow in comparison with that in a non-boundary region is carried out to remove noise with a controlled noise removing characteristic. The smoothing is carried out using, for example, a first filtering section that carries out the smoothing process for input images and images in the non-boundary region or reduced images thereof, and a second filtering section that carries out a smoothing process for images in the boundary region. In addition, in the boundary region, the smoothing is carried out with a smoothing unit that is narrow in comparison with that for the non-boundary region based on the result of the boundary region setting, thereby carrying out noise removal in which color fringing is suppressed. Further, the smoothed images produced by the first filtering section and the second filtering section are mixed with each other so as to obtain a noise-removed image in which color fringing is suppressed in the boundary region. Further, at least one of the first filtering section and the second filtering section may be composed of a plurality of filters having characteristics different from each other, so that the switching of filters or changing of a combination of filters is carried out based on a result of the color discrimination. A region of a color in which resolution degradation in noise removal is likely to be perceived is discriminated in the color discrimination of each pixel in the input image, and in the region of the color in which resolution degradation is likely to be perceived, changing of the filter or the combination is carried out so that it will be a filter or a combination that is less likely to cause resolution degradation.

Further, the smoothed image produced by smoothing the input image and the input image are mixed together, and based on a result of the color discrimination, the rate of the input image is increased in the region of the color in which resolution degradation is likely to be perceived compared to that in the region of a different color so as to change the noise removing characteristic.

Another embodiment of the present technology is an image processing method, including:

discriminating a color of each pixel of an input image;

setting a boundary region of a predetermined color based on a result of the color discrimination; and

controlling a noise removing characteristic based on a result of the boundary region setting to remove noise from the input image.

Another embodiment of the present technology is a program that allows a computer to execute noise removal of an input image, including:

discriminating a color of each pixel of the input image;

setting a boundary region of a predetermined color based on a result of the color discrimination; and

controlling a noise removing characteristic based on a result of the boundary region setting to remove noise from the input image.

Incidentally, the program according to one embodiment of the present technology can be provided to, for example, general-purpose computers that can execute various program codes using a storage medium or a communication medium that provides the program in a computer-readable form. In particular, the program can be provided using a storage medium such as an optical disk, a magnetic disk or a semiconductor memory, or through a communication medium such as a network. Providing the program in a computer-readable form, processes according to the program are implemented on the computer.

According to the embodiments of the present technology, the color of each pixel of an input image is discriminated, and a boundary region of a predetermined color is set based on a result of the color discrimination. The noise removing characteristic is controlled based on the result of the boundary region setting to remove noise from the input image. Accordingly, by switching the noise removing characteristic on a boundary of a color in which color fringing is likely to be perceived, color fringing upon noise removal can be suppressed.

The above and other features and advantages of the present disclosure will become apparent from the following description and the appended claims, taken in conjunction with the accompanying drawings.

### BRIEF DESCRIPTION OF THE DRAWINGS

FIG. 1 is a block diagram showing the configuration of a system which uses an image processing apparatus according to an embodiment of the present technology;

FIG. 2 is a block diagram showing a basic configuration of the image processing apparatus;

FIG. 3 is a flow chart of the operation of a noise removal processing section;

FIGS. 4A to 4D are timing charts illustrating the operations of a color discrimination section and a boundary region setting section;

FIG. 5 is a block diagram showing the configuration of a first mode of the noise removing section;

FIG. 6 is a block diagram showing a first configuration of a smoothing section;

FIG. 7 is a block diagram showing a second configuration of the smoothing section;

FIG. 8 is a block diagram showing a third configuration of the smoothing section;

FIG. 9 is a block diagram showing a general configuration of a connection section;

FIG. 10 is a table illustrating the controlling operation of a switch controlling section;

FIG. 11 is a block diagram showing the configuration of a smoothed image mixing section;

FIGS. 12A to 12C are timing charts illustrating first operation of a coefficient setting section;

FIGS. 13A to 13C are timing charts illustrating second operation of the coefficient setting section;

FIGS. 14A to 14C are timing charts illustrating first operation of a coefficient setting section in a mixing section;

FIGS. 15A to 15C are timing charts illustrating second operation of the coefficient setting section in the mixing section;

FIG. 16 is a block diagram showing a configuration of a second mode of the noise removing section;

FIG. 17 is a block diagram showing a fourth configuration of the smoothing section;

FIG. 18 is a block diagram showing a general configuration of a connection section;

FIG. 19 is a table illustrating the controlling operation of a switch controlling section;

FIG. 20 is a block diagram showing the configuration of a filtering section capable of switching processing characteristics; and

FIG. 21 is a block diagram showing the configuration of a noise removal processing section that uses component signals.

### DETAILED DESCRIPTION OF THE PREFERRED EMBODIMENT

Hereafter, an embodiment of the present technology is described. The present technology is described in the following order:

1. Configuration of System Employing Image Processing Apparatus According to the Embodiment

2. Basic Configuration and Operation of the Image Processing Apparatus

3. First Mode of the Noise Removing Section

3-1. Configuration and Operation of the First Mode of the Noise Removing Section

3-2. Configuration and Operation of the Smoothing Section

3-2-1. First Configuration and Operation of the Smoothing Section

3-2-2. Second Configuration and Operation of the Smoothing Section

3-2-3. Third Configuration and Operation of the Smoothing Section

3-2-4. Configuration and Operation of the Smoothed Image Mixing Section

3-3. Configuration and Operation of the Mixing Section

4. Second Mode of the Noise Removing Section

4-1. Configuration and Operation of the Second Mode of the Noise Removing Section

4-2. Configuration and Operation of the Smoothing Section

5. Other Configurations of the Filtering Section

6. Other Modes of the Noise removal processing Section

### <1. Configuration of System Employing Image Processing Apparatus According to the Embodiment>

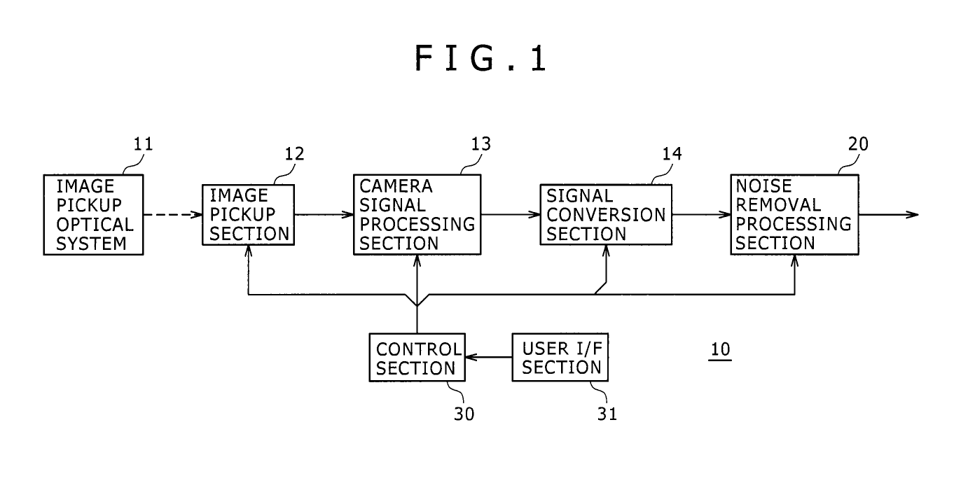

FIG. 1 exemplifies a configuration of a system, for example, an image pickup apparatus, which employs an image processing apparatus according to one embodiment of the present technology. The image pickup apparatus 10 includes an image pickup optical system 11, an image pickup section 12, a camera signal processing section 13, a signal conversion section 14, a noise removal processing section 20 and a control section 30.

The image pickup optical system 11 is composed mainly of a lens, and it forms an optical image of an object (not illustrated) on a light receiving surface of the image pickup section 12.

The image pickup section 12 is composed of a solid-state image pickup device such as a CMOS (Complementary Metal Oxide Semiconductor) device or a CCD (Charge Coupled Device) device. The image pickup section 12 produces a picked up image signal corresponding to the optical image formed on the light receiving surface by the image pickup optical system 11. Further, the image pickup section 12 carries out processes such as correlation duplex sampling, analog amplification and A/D conversion for the picked up image signal and outputs the processed signal to the camera signal processing section 13.

The camera signal processing section 13 carries out processes such as gamma correction, luminance adjustment and color correction for the image signal supplied from the image pickup section 12 and outputs the processed image signal to the signal conversion section 14.

The signal conversion section 14 converts the image signal supplied from the camera signal processing section 13 into an image signal of a predetermined type, for example, into a luminance signal and color difference signals and outputs the resulting signals to the noise removal processing section 20.

The noise removal processing section 20 which corresponds to the image processing apparatus of one embodiment of the present technology carries out a noise removing process for the image signal supplied from the signal conversion section 14. The configuration and operation of the noise removal processing section 20 are described later.

A user interface (I/F) section 31 is connected to the control section 30. The user I/F section 31 accepts operation inputs from the user, and includes a power switch and various operation keys such as a shutter key and a zoom key as well as keys for displaying menu, selecting a menu item and carrying out various settings. The user I/F section 31 outputs an operation signal to the control section 30 according to the user operation.

The control section 30 is composed of elements such as a microcomputer and executes a program stored therein to control the components of the image pickup apparatus 10 based on the operation signal so that the image pickup apparatus 10 operates in accordance with the user operation.

### <2. Basic Configuration and Operation of the Image Processing Apparatus>

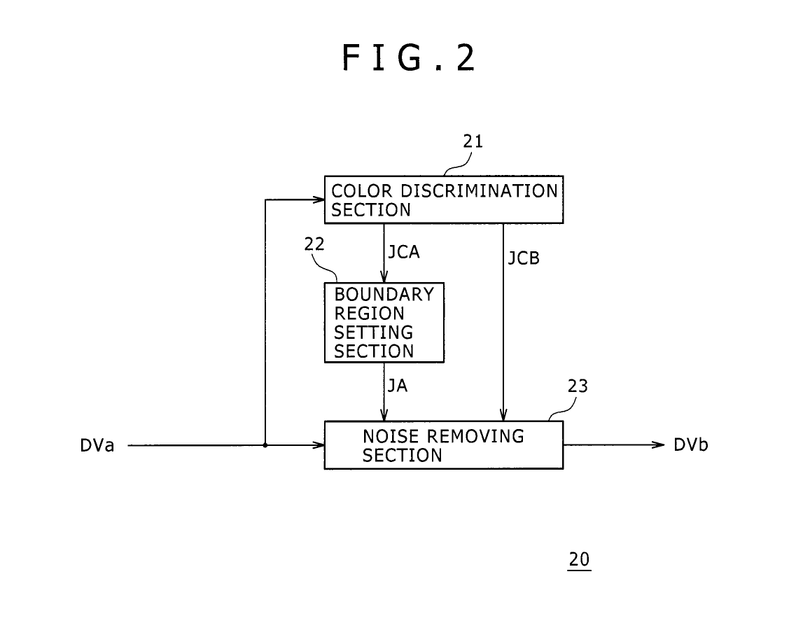

FIG. 2 shows a basic configuration of the image processing apparatus. The noise removal processing section 20 which is the image processing apparatus includes a color discrimination section 21, a boundary region setting section 22 and a noise removing section 23.

The color discrimination section 21 discriminates the color of each pixel of an input image based on an image signal DVa of the input image. The color discrimination section 21 produces a color discrimination signal indicative of a result of the color discrimination and outputs the produced signal to the boundary region setting section 22 and the noise removing section 23. Further, in the color discrimination, the color discrimination section 21 discriminates a color in which color fringing is likely to be perceived upon noise removal or a color in which resolution degradation is likely to be perceived. The color discrimination section 21 outputs to the boundary region setting section 22 a color discrimination signal JCA indicating the result of the discrimination of a color in which color fringing is likely to be perceived, and to the noise removing section 23 a color discrimination signal JCB indicating the result of the discrimination of a color in which resolution degradation is likely to be perceived.

The boundary region setting section 22 sets a boundary region indicative of the boundary of a region of the color in which color fringing is likely to be perceived upon noise removal based on the color discrimination signal JCA. The boundary region setting section 22 outputs a boundary region signal JA indicative of the set boundary region to the noise removing section 23.

The noise removing section 23 controls operations for noise removal based on the boundary region signal JA and the color discrimination signal JCB so as to carry out noise removal with suppressed color fringing and resolution degradation, and outputs a noise-removed image signal DVb.

Incidentally, the color discrimination section 21 shown in FIG. 2 carries out the discrimination of a color in which color fringing is likely to be perceived upon noise removal or a color in which resolution degradation is likely to be perceived in the color discrimination. The discrimination of a color in which color fringing or resolution degradation is likely to be perceived may be carried out in the boundary region setting section 22 or the noise removing section 23 based on the color discrimination result of each pixel from the color discrimination section 21. The following description describes a case where the discrimination of a color in which fringing or resolution degradation is likely to be perceived is carried out in the color discrimination section 21.

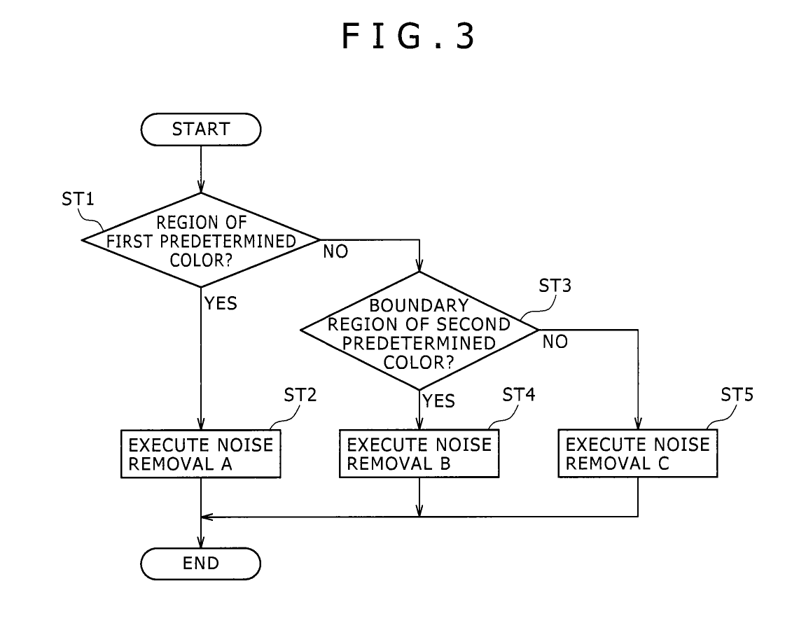

FIG. 3 is a flow chart of the operation of the noise removal processing section. First, at step ST1, the noise removal processing section 20 discriminates whether or not the region in question is a region of a first predetermined color. In particular, the noise removal processing section 20 discriminates, by the color discrimination section 21, whether or not the pixel of the input image is a pixel in a region of the first predetermined color in which resolution degradation is likely to be perceived in noise removal. If it is discriminated that the pixel of the input image is a pixel in a region of the first predetermined color, then the noise removal processing section 20 advances to step ST2. On the other hand, if it is discriminated that the pixel of the input image is not a pixel in a region of the first predetermined color, then the noise removal processing section 20 advances to step ST3.

At step ST2, the noise removal processing section 20 carries out noise removal A. In particular, the noise removal processing section 20 carries out, by the noise removing section 23, the noise removal A which is a noise removing process with reduced resolution degradation.

At step ST3, the noise removal processing section 20 discriminates whether or not the region in question is a boundary region of a second predetermined color. In particular, the noise removal processing section 20 discriminates, by the color discrimination section 21, whether or not the pixel of the input image is in a pixel in a region of the second predetermined color in which color fringing is likely to be perceived upon noise removal. Further, according to the result of the color discrimination of the second predetermined color, the noise removal processing section 20 sets a boundary region indicating the boundary of a region of the second predetermined color by the boundary region setting section 22. If the pixel of the input image is a pixel in the boundary region, then the noise removal processing section 20 advances to step ST4. On the other hand, if the pixel of the input image is not a pixel in the boundary region, then the noise removal processing section 20 advances to step ST5.

At step ST4, the noise removal processing section 20 carries out noise removal B. In particular, the noise removal processing section 20 carries out, by the noise removing section 23, the noise removal B for reduced color fringing.

At step ST5, the noise removal processing section 20 carries out noise removal C. Since the pixel of the input image is neither a boundary region of the first predetermined color nor a boundary region of the second predetermined color, the noise removing section 23 of the noise removal processing section 20 carries out the noise removal C in which resolution degradation and color fringing are not taken into consideration. For example, the noise removing section 23 carries out noise removal C that is simpler than the noise removal process A or B.

It is to be noted that the first predetermined color and the second predetermined color may be the same or different colors. For example, in the case where resolution degradation is likely to be perceived upon noise removal in a red region and color fringing is likely to be perceived upon noise removal on a boundary of the red region, the first and second predetermined colors are the same. Further, if resolution degradation is likely to be perceived also in a blue region upon noise removal, and noise removal with reduced resolution degradation is to be carried out for the blue region as well, the first predetermined colors will be red and blue and the second predetermined color will be only red.

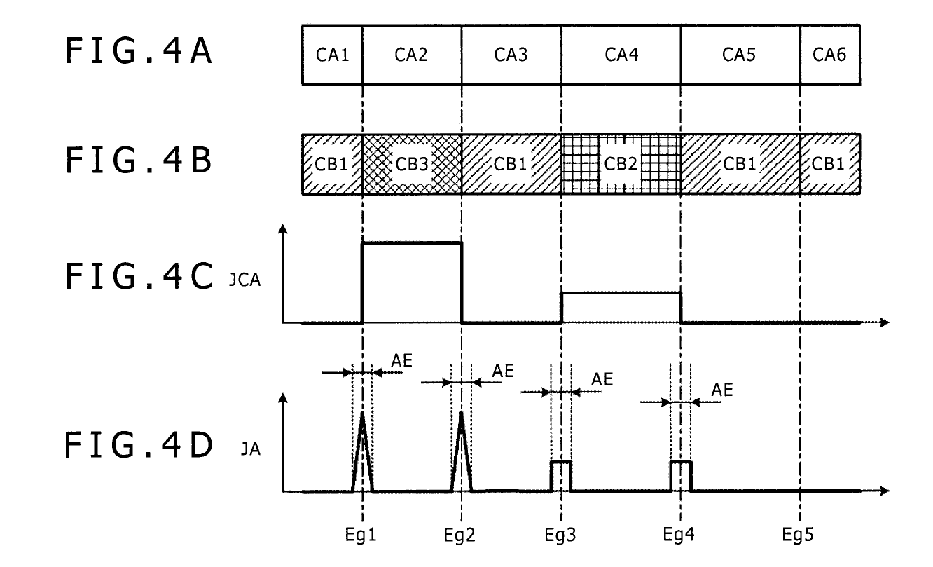

FIG. 4 illustrates the operations of the color discrimination section 21 and boundary region setting section 22 in the noise removal processing section 20. For example, FIG. 4A illustrates an input image configured from color regions “CA1,” “CA2,” “CA3,” “CA4,” “CA5” and “CA6.” The boundary between the region “CA1” and the region “CA2” is defined as “Eg1.” Similarly, boundaries between the regions of “CA2,” “CA3,” “CA4,” “CA5” and “CA6” are defined as “Eg2,” “Eg3,” “Eg4” and “Eg5.”

The color discrimination section 21 discriminates whether or not the color in question is a color that color fringing is likely to be perceived. FIG. 4B illustrates results of the discrimination. The discrimination result “CB1” indicates that the color is a color in which color fringing does not occur. The discrimination result “CB3” indicates that the color is a color in which color fringing is likely to be perceived. Further, the discrimination result “CB2” indicates that the color is a color in which color fringing is less likely to be perceived compared to the discrimination result “CB3.” The color discrimination section 21 supplies to the boundary region setting section 22 color discrimination signals indicating the results of the color discrimination. For example, as shown in FIG. 4C, the signal level of the color discrimination signal JCA is set such that it is high when the color is a color in which color fringing is likely to be perceived and low when the color is a color in which color fringing is less likely to be perceived. Further, the color discrimination section 21 similarly carries out discrimination of a color that is likely to suffer resolution degradation, and produces a color discrimination signal JCB indicating the result of the color discrimination and supplies it to the noise removing section 23.

The boundary region setting section 22 sets a boundary region AE based on the color discrimination signal JCA from the color discrimination section 21. FIG. 4D illustrates a boundary region signal JA generated in the boundary region setting section 22. For example, the boundary region setting section 22 generates a boundary region signal JA indicating a boundary region AE by setting a predetermined region width from the boundary of the color in which color fringing is perceived as the boundary region AE. Regarding the boundary region signal JA illustrated in FIG. 4D, at the boundaries “Eg1” and “Eg2” which are the boundaries of a color whose discrimination result is “CB3,” the signal level increases until it reaches the boundary and decreases after passing the boundary. Alternatively, the boundary region signal JA may be a binary signal that indicates a predetermined signal level in boundary regions. For example, the boundary region signal JA may be a binary signal indicating whether or not the region is a boundary region, as is the case with the boundaries “Eg3” and “Eg4” which are the boundaries of a color whose discrimination result is “CB2.” Incidentally, if a boundary region signal JA having a signal level that varies in accordance with the distance from a boundary is produced, it will be possible to determine its position in the boundary region based on the boundary region signal JA. Further, while FIG. 4D shows a case where the boundary region signal JA is defined setting the boundary as the center, the boundary may be defined differently so long as the boundary is included in the boundary region. For example, the boundary region may be set such that the boundary is positioned at one of the sides of the boundary region.

### <3. First Mode of the Noise Removing Section>

Next, the noise removing section which controls noise removal based on a color discrimination signal JCB and a boundary region signal JA representing color discrimination results is described.

### <3-1. Configuration and Operation of the First Mode of the Noise Removing Section>

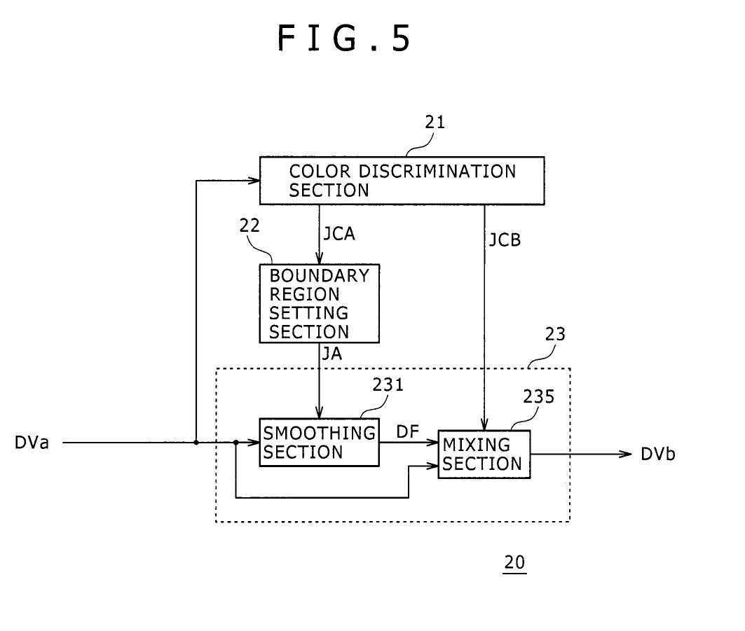

FIG. 5 shows the configuration of a first mode of the noise removing section 23. The noise removing section 23 includes a smoothing section 231 and a mixing section 235.

The smoothing section 231 carries out smoothing of the input image to reduce noise. Further, the smoothing section 231 controls the noise removing characteristic by carrying out, in a boundary region, a smoothing process with a smoothing unit narrower than that for a non-boundary region based on the boundary region signal JA from the boundary region setting section 22. The smoothing section 231 outputs to the mixing section 235 an image signal DF after smoothing.

The mixing section 235 receives an image signal DVa of the input image and the smoothed image signal DF. The mixing section 235 controls the mixture ratio between the image signal DVa of the input image and the smoothed image signal DF based on the color discrimination signal JCB from the color discrimination section 21 and outputs a noise-removed image signal DVb.

Configuring the noise removing section 23 as described above, in a boundary region of a color in which color fringing is likely to be perceived, the smoothing section 231 can carry out noise removal wherein the effect of smoothing is weakened and suppress color fringing according to the boundary region signal JA from the boundary region setting section 22. Further, the mixing section 235 controls the mixture ratio between the image signal DVa of the input image and the image signal DF after smoothing based on the color discrimination signal JCB from the color discrimination section 21. Therefore, for example, in a color region in which resolution degradation is likely to occur, the rate of the image signal DVa of the input image can be increased to carry out noise removal with reduced resolution degradation.

### <3-2. Configuration and Operation of the Smoothing Section>

Next, the smoothing section 231 employed in the noise removing section 23 is described.

### <3-2-1. First Configuration and Operation of the Smoothing Section>

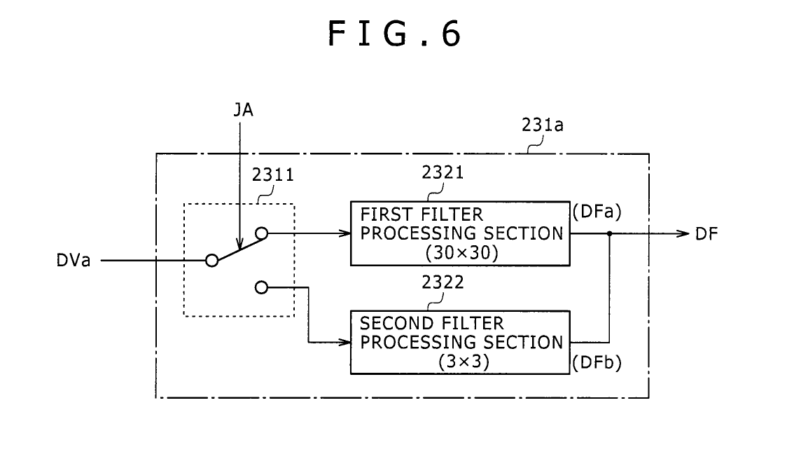

FIG. 6 shows a first configuration of the smoothing section. The smoothing section 231a of the first configuration includes a signal switching section 2311, a first filtering section 2321, and a second filtering section 2322.

The signal switching section 2311 controls switching of the image signal DVa of the input image based on the boundary region signal JA. The signal switching section 2311 outputs the image signal DVa to the first filtering section 2321 when the boundary region signal JA does not represent a boundary region of a color in which color fringing is likely to be perceived. On the other hand, when the boundary region signal JA represents a boundary region of a color in which color fringing is likely to be perceived, then the signal switching section 2311 outputs the image signal DVa to the second filtering section 2322. For example, when the boundary region signal JA exhibits a value equal to or higher than a threshold value, then the signal switching section 2311 determines that the boundary region signal JA represents a boundary region of a color in which color fringing is likely to be perceived, and controls the switching accordingly.

The first filtering section 2321 is configured such that it provides a higher smoothing effect than the second filtering section 2322. For example, the first filtering section 2321 carries out, for example, averaging operation using a signal of 30 pixels×30 pixels and generates an image signal DFa of the smoothed image.

The second filtering section 2322 is configured such that it provides a lower smoothing effect than the first filtering section 2321. For example, the second filtering section 2322 carries out, for example, averaging operation using a signal of 3 pixels×3 pixels and generates an image signal DFb of the smoothed image. In particular, in a boundary region of a color in which color fringing is likely to be perceived, the number of pixels used for averaging is smaller and the effect of smoothing is lower than that in a non-boundary region. Therefore, according to the image signal DFb, color fringing is suppressed compared to when noise removal is carried out by the first filtering section 2321.

If the smoothing section 231a is configured in such manner, in a boundary region of a color in which color fringing is likely to be perceived, the image signal DFb is outputted as the image signal DF of the smoothed image. On the other hand, in a non-boundary region, the image signal DFa is outputted as the image signal DF of the smoothed image. Accordingly, the image signal DF outputted from the smoothing section 231a becomes a smoothed image in which color fringing is suppressed on the boundary of a color in which color fringing is likely to be perceived.

### <3-2-2. Second Configuration and Operation of the Smoothing Section>

Next, a second configuration of the smoothing section is described. In the second configuration, the processing time is reduced compared to the first configuration.

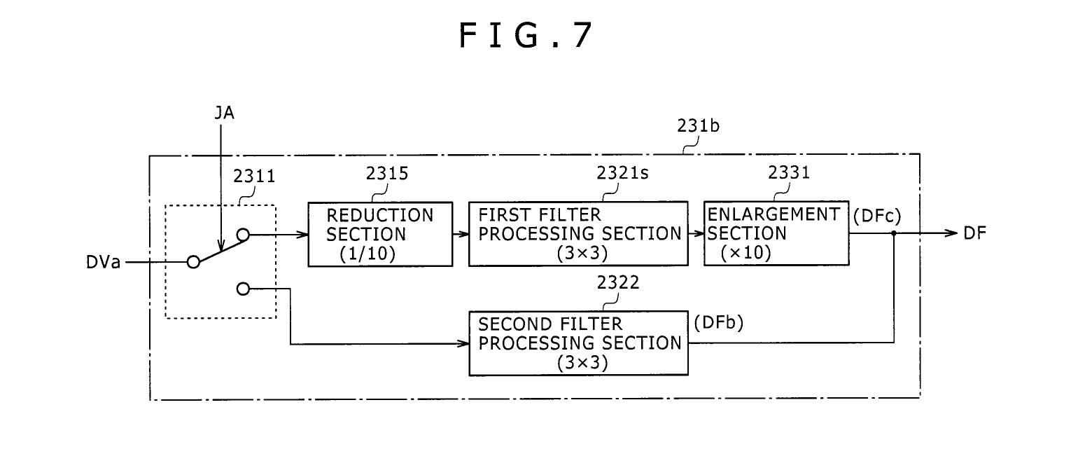

FIG. 7 shows the second configuration of the smoothing section. The smoothing section 231b of the second configuration includes a signal switching section 2311, a reduction section 2315, a first filtering section 2321s, an enlargement section 2331 and a second filtering section 2322.

The signal switching section 2311 controls switching of an input image signal based on the boundary region signal JA. When the boundary region signal JA does not indicate a boundary region of a color in which color fringing is likely to be perceived, the signal switching section 2311 outputs the image signal DVa of the input image to the reduction section 2315. On the other hand, when the boundary region signal JA indicates a boundary region of a color in which color fringing is likely to be perceived, then the signal switching section 2311 outputs the image signal DVa of the input signal to the second filtering section 2322.

The reduction section 2315 reduces the size of the input image and generates a reduced image signal and outputs it to the first filtering section 2321s. For example, if the first filtering section 2321s is to use a signal of 3 pixels×3 pixels for averaging so as to obtain an effect similar to that of smoothing with 30 pixels×30 pixels by the first filtering section 2321 in the first configuration, the reduction section 2315 carries out a process of reducing the input image to 1/10.

The first filtering section 2321s is configured such that it uses the image signal of the reduced image so that the effect of smoothing is increased in comparison with the second filtering section 2322. For example, the first filtering section 2321s can achieve an effect of smoothing similar to that by the first filtering section 2321 of the first configuration by carrying out averaging with 3 pixels×3 pixels using an image signal of a 1/10 reduced image. The first filtering section 2321s outputs the image signal of the smoothed image to the enlargement section 2331.

The enlargement section 2331 carries out an enlargement process corresponding to the reduction process of the reduction section 2315 to produce an image signal DFc of the smoothed image having the size or pixel number equal to that before the reduction by the reduction section 2315. The enlargement section 2331 carries out the enlargement process of the image using such a method as the nearest neighbor, bilinear, or bicubic method. For example, when the nearest neighbor method is used, the enlargement section 2331 calculates at which coordinates before enlargement a pixel after the enlargement had been positioned and uses a signal of the pixel nearest to the calculated position as a signal of the pixel after the enlargement.

The second filtering section 2322 is configured such that it provides an effect of smoothing lower than that by the smoothing process by the reduction section 2315, the first filtering section 2321s and the enlargement section 2331. For example, the second filtering section 2322 uses a signal of 3 pixels×3 pixels to carry out averaging and produces an image signal DFb of a smoothed image. In particular, in a boundary region of a color in which color fringing is likely to be perceived, since the number of pixels used for averaging operation is small and the smoothing effect is low compared to those of a non-boundary region, the image signal DFb becomes an image signal in which color fringing is suppressed compared to that of when noise removal is carried out by the first filtering section 2321s.

Incidentally, the reduction ratio of the reduction section 2315 may be set such that the number of pixels used in the averaging for obtaining a desired smoothing effect by the first filtering section 2321s becomes equal to the number of pixels used in the averaging by the second filtering section 2322. In such case, it is possible to carry out the processes of the second filtering section 2322 and the first filtering section 2321s by a single filtering section.

If the smoothing section 231b is configured as described above, in a boundary region of a color in which color fringing is likely to be perceived, the image signal DFb is outputted as the image signal DF of the smoothed image. On the other hand, in a non-boundary region, the image signal DFc is outputted as the image signal DF of the smoothed image. Accordingly, the image signal DF outputted from the smoothing section 231b will be an image signal of a smoothed image in which color fringing is suppressed on the boundary of a color in which color fringing is likely to be perceived

Further, the smoothing section 231b can reduce the number of pixels used in averaging by carrying out averaging by the first filtering section 2321s after reducing the input image. The processing time can therefore be reduced compared to that of the first configuration.

### <3-2-3. Third Configuration and Operation of the Smoothing Section>

Next, a third configuration of the smoothing section is described. In the third configuration, in comparison with the first configuration and the second configuration, images processed by different filtering sections are connected more smoothly.

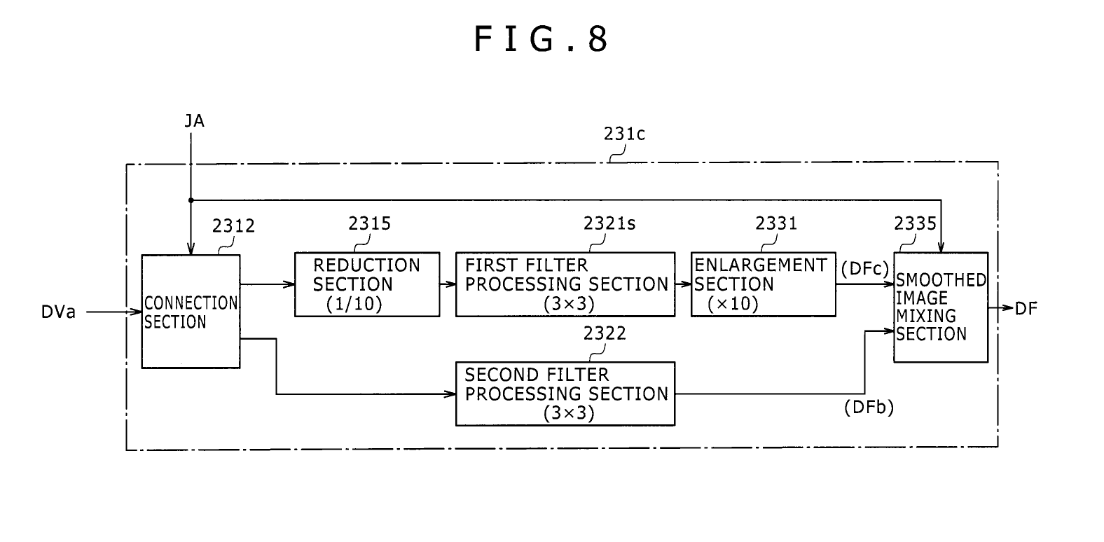

FIG. 8 shows the third configuration of the smoothing section. The smoothing section 231c of the third configuration includes a connection section 2312, a reduction section 2315, a first filtering section 2321s, an enlargement section 2331, a second filtering section 2322 and a smoothed image mixing section 2335.

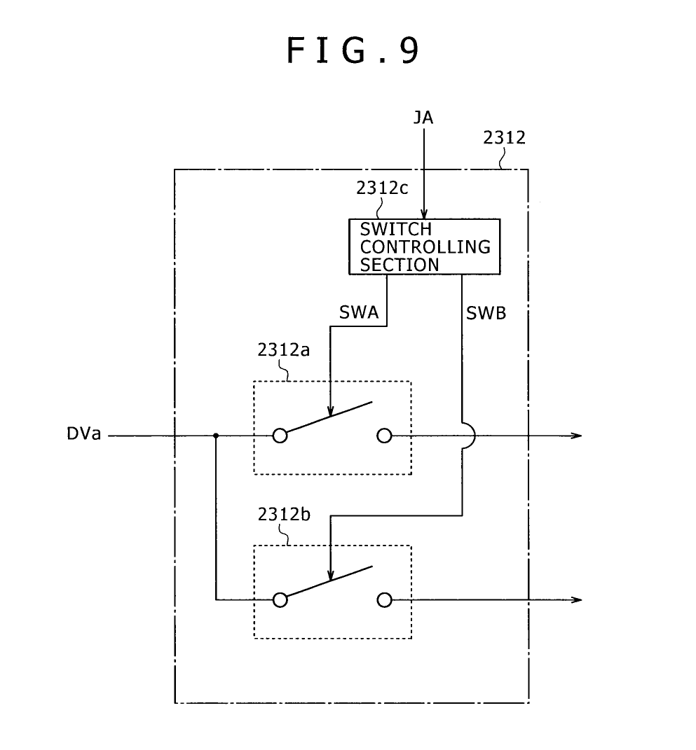

The connection section 2312 controls provision of the image signal DVa of the input image based on the boundary region signal JA. FIG. 9 shows a general configuration of the connection section 2312. The connection section 2312 includes switches 2312a and 2312b and a switch controlling section 2312c. The switch controlling section 2312c produces a switch controlling signal SWA based on the boundary region signal JA to control the switch 2312a. Further, the switch controlling section 2312c produces a switch controlling signal SWB based on the boundary region signal JA to control the switch 2312b. The connection section 2312 controls the switches 2312a and 2312b in such manner based on boundary region signals JA and thereby controls supply of image signals DVa to the reduction section 2315 and the second filtering section 2322.

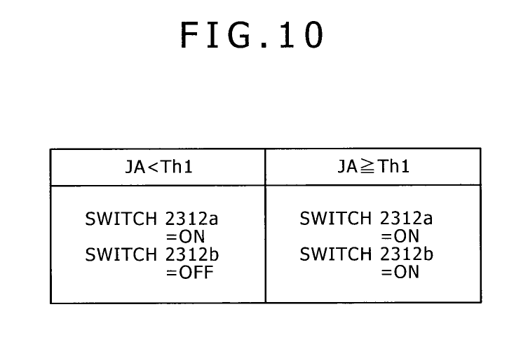

FIG. 10 illustrates the controlling operation of the switch controlling section 2312c. For example, the switch controlling section 2312c compares the boundary region signal JA with a threshold value Th1 and sets only the switch 2312a to the on state when the signal level of the boundary region signal JA is lower than the threshold value Th1. On the other hand, when the signal level of the boundary region signal JA is equal to or higher than the threshold value Th1, the switch controlling section 2312c sets both of the switches 2312a and 2312b to the on state. In particular, when the signal level of the boundary region signal JA is lower than the threshold value Th1, the switch controlling section 2312c controls the switches so that the smoothing process is executed by the first filtering section 2321s. When the signal level of the boundary region signal JA is equal to or higher than the threshold value Th1, the switch controlling section 2312c controls the switches so that the smoothing process is executed by the second filtering section 2322 and the first filtering section 2321s.

The reduction section 2315 carries out reduction of the input signal supplied from the connection section 2312 to produce a reduced image signal and outputs it to the first filtering section 2321s. For example, when the reduction section 2315 is to carry out averaging using a signal of 3 pixels×3 pixels and obtain an effect similar to that of averaging with 30 pixels×30 pixels by the first filtering section 2321 in the first configuration, the input image is reduced to 1/10.

The first filtering section 2321s is configured such that it uses the image signal of the reduced image so that the smoothing effect is enhanced compared to the second filtering section 2322. For example, the first filtering section 2321s uses the image signal of the reduced image to carry out averaging operation of 3 pixels×3 pixels to obtain an effect similar to that of averaging operation by the first filtering section 2321 in the first configuration. The first filtering section 2321s outputs the image signal of the smoothed image to the enlargement section 2331.

The enlargement section 2331 carries out an enlargement process corresponding to the reduction process by the reduction section 2315 to produce an image signal DFc of a smoothed image having an image size or a number of pixels equal to that before the reduction by the reduction section 2315. The enlargement section 2331 outputs the produced image signal DFc of the smoothed image to the smoothed image mixing section 2335.

The second filtering section 2322 is configured such that its smoothing effect is lower than that of the smoothing process carried out by the reduction section 2315, the first filtering section 2321s and the enlargement section 2331. For example, the second filtering section 2322 uses a signal of 3 pixels×3 pixels to carry out averaging operation to produce an image signal DFb of a smoothed image. The second filtering section 2322 outputs the produced image signal DFb of the smoothed image to the smoothed image mixing section 2335.

### <3-2-4. Configuration and Operation of the Smoothed Image Mixing Section>

Next, the smoothed image mixing section 2335 employed in the smoothing section is described. The smoothed image mixing section 2335 uses coefficients Kb and Kc determined based on a result of comparison between the boundary region signal JA and the threshold value Th1 to adjust and add the signal levels of the image signals DFb and DFc of the smoothed image. The following expression (1) given below represents the mixing arithmetic processing carried out by the smoothed image mixing section 2335:

DF=Kb×DFb+Kc×DFc (1)

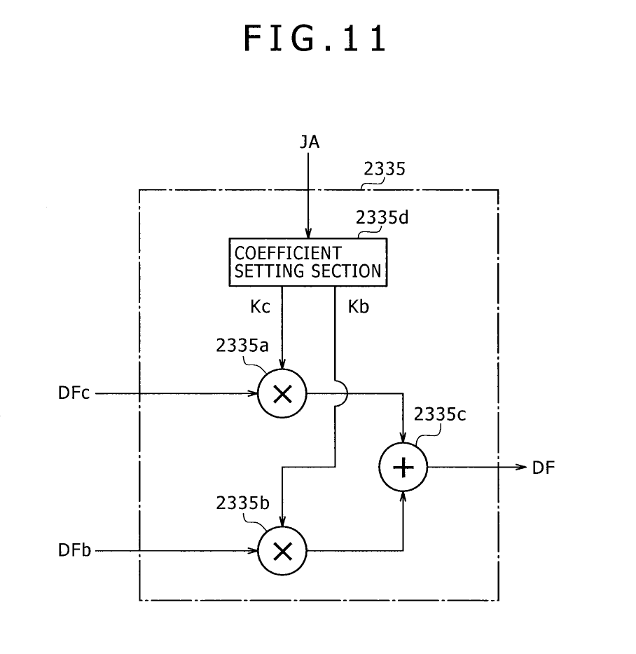

FIG. 11 shows the configuration of the smoothed image mixing section 2335. The smoothed image mixing section 2335 includes multiplication sections 2335a and 2335b, an addition section 2335c and a coefficient setting section 2335d. The multiplication section 2335a carries out the calculation of “Kc×DFc” and outputs the calculation result to the addition section 2335c. The multiplication section 2335b carries out the calculation of “Kb×DFb” and outputs the calculation result to the addition section 2335c. The addition section 2335c adds the image signals supplied from the multiplication sections 2335a and 2335b and produces an image signal DF of a smoothed image represented by the expression (1) given hereinabove.

The coefficient setting section 2335d produces coefficients Kb and Kc based on a result of comparison between the boundary region signal JA and the threshold value Th1. The produced coefficient Kc is outputted to the multiplication section 2335a and the coefficient Kb is outputted to the multiplication section 2335b.

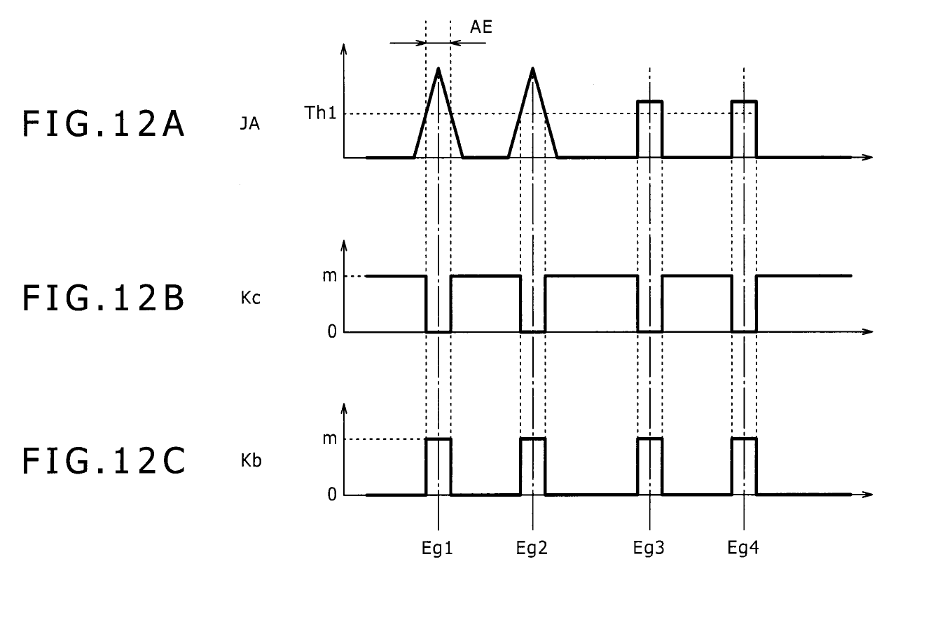

FIGS. 12A to 12C illustrate first operation of the coefficient setting section 2335d. FIG. 12A illustrates the boundary region signal JA, which is a signal similar to that illustrated in FIG. 4D. FIG. 12B illustrates the coefficient Kc and FIG. 12C illustrates the coefficient Kb.

When the connection section 2312 controls provision of an image signal based on the result of comparison between the boundary region signal JA and the threshold value Th1, if the boundary region signal JA is lower than the threshold value Th1, the image signal DVa is not supplied to the second filtering section 2322. Accordingly, when the boundary region signal JA is lower than the threshold value Th1, the smoothed image mixing section 2335 sets the coefficients Kb=0 and Kc=m (e.g., m=1). On the other hand, when the boundary region signal JA is equal to or higher than the threshold value Th1, since the image signal DVa is supplied to the second filtering section 2322, the smoothed image mixing section 2335 sets the coefficients Kb=m and Kc=0.

When the coefficients Kb and Kc are set as above, if filtering is carried out using the second filter section 2322, the image signal DFb is outputted as the image signal DF. On the other hand, if the filtering does not use the second filtering section 2322, the image signal DFc is outputted as the image signal DF.

Accordingly, in a boundary region of a color in which color fringing is likely to be perceived, a smoothed image with low smoothing effect is outputted from the smoothing section, and consequently, color fringing can be suppressed.

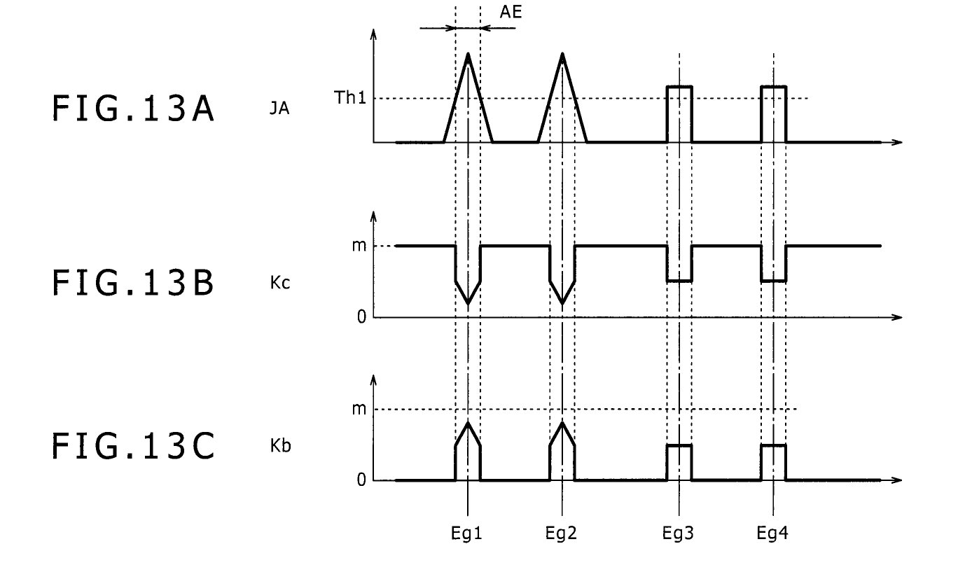

FIGS. 13A to 13C illustrate second operation of the coefficient setting section 2335d. In the second operation, when the boundary region signal JA is equal to or higher than the threshold value Th1, not only the image signal DFb smoothed by the second filtering section 2322 but also the image signal DFc smoothed by the first filtering section 2321s is used.

FIG. 13A illustrates the boundary region signal JA. FIG. 13B illustrates the coefficient Kc and FIG. 13C illustrates the coefficient Kb.

When the connection section 2312 controls provision of an image signal based on the result of comparison between the boundary region signal JA and the threshold value Th1, if the boundary region signal JA is lower than the threshold value Th1, the image signal DVa is not supplied to the second filtering section 2322. Accordingly, when the boundary region signal JA is lower than the threshold value Th1, the smoothed image mixing section 2335 sets the coefficients Kb=0 and Kc=m (e.g., m=1). Meanwhile, if the boundary region signal JA is equal to or higher than the threshold value Th1, the smoothed image mixing section 2335 controls the coefficients Kb and Kc according to the boundary region signal JA, so as to adjust the mixing ratio such that the rate of the image signal DFb increases in proportion to the signal level of the boundary region signal JA. In other words, as the signal level of the boundary region signal JA becomes higher, the coefficient Kc decreases while the coefficient Kb increases.

If the coefficients Kb and Kc are set in such manner, when filtering using the second filtering section 2322 is carried out, the image signal DFb and the image signal DFc are mixed and the mixed image signal is outputted as the image signal DF. As the signal level of the boundary region signal JA increases, the rate of the image signal DFb is increased. Accordingly, in a boundary region of a color in which color fringing is likely to be perceived, an image that is a mixture of an image processed with a high smoothing effect and an image processed with a low smoothing effect can be outputted. Further, since the rate of an image processed with a low smoothing effect increases as it approaches a boundary of a color in which color fringing is likely to be perceived, color fringing at the boundary can be reduced. Incidentally, in the case shown in FIGS. 13A to 13C, when the boundary region signal JA and the threshold value Th1 are equal to each other, the image signal DFb and the image signal DFc are mixed at a predetermined ratio. However, it is also possible to set the coefficients Kb=0 and Kc=m, and decrease the coefficient Kc and increase the coefficient Kb as the signal level of the boundary region signal JA increases.

Further, when the boundary region signal JA is a binary signal, and its level is equal to or higher than the threshold value Th1, the image signal DFb and the image signal DFc may be mixed at a predetermined ratio. In this case, since an image processed with a low smoothing effect is mixed into an image processed with a high smoothing effect, in a boundary region of a color in which color fringing is likely to be perceived, the smoothing effect can be decreased.

Configuring the smoothed image mixing section 2335 as described above, the effect of smoothing is lowered in a boundary region of a color in which color fringing is likely to be perceived, thereby suppressing color fringing in noise removal.

### <3-3. Configuration and Operation of the Mixing Section>

Next, the mixing section 235 used in the noise removing section is described. The mixing section 235 uses coefficients Kf and Kg determined based on the color discrimination signal JCB to adjust and add the signal levels of the image signal DF of the smoothed image and the image signal DVa of the input image. The following expression (2) represents the arithmetic processing executed by the mixing section 235.

DVb=Kf×DF+Kg×DVa (2)

The mixing section 235 is configured similarly to the smoothed image mixing section 2335 but the image signals inputted to the multipliers and coefficients set by the coefficient setting section are different.

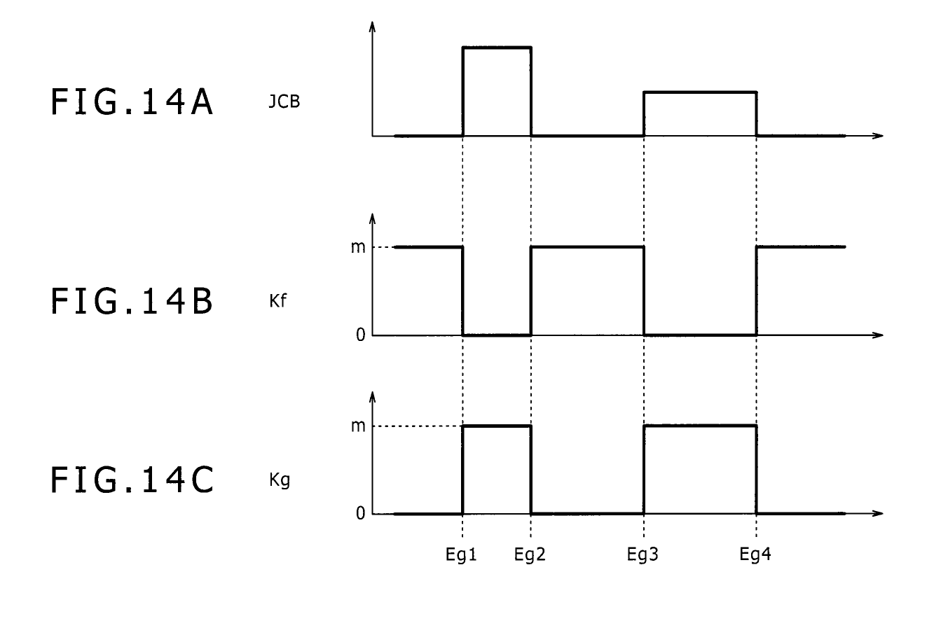

FIGS. 14A to 14C illustrate first operation of the coefficient setting section of the mixing section 235. FIG. 14A illustrates the color discrimination signal JCB. FIG. 14B illustrates the coefficient Kf and FIG. 14C illustrates the coefficient Kg.

In a region of a color in which resolution degradation is likely to be perceived, the mixing section 235 selects the image signal DVa of the input image in order to reduce resolution degradation. On the other hand, in a region that is not a region of a color in which resolution degradation is likely to be perceived, the mixing section 235 selects the image signal DF of the smoothed image so that a noise removal effect is obtained.

When the color discrimination signal JCB does not indicate a region of a color in which resolution degradation is likely to be perceived, the mixing section 235 sets the coefficients Kf=m (e.g., m=1) and Kg=0. On the other hand, when the color discrimination signal JCB indicates a region of a color in which resolution degradation is likely to be perceived, the mixing section 235 sets the coefficients Kf=0 and Kg=m (e.g., m=1).

If the coefficients Kf and Kg are set as above, in a region that is not of a color in which resolution degradation is likely to be perceived, the image signal DF of the smoothed image is outputted as the image signal DVb. On the other hand, in a region of a color in which resolution degradation is likely to be perceived, the image signal DVa of the input image is outputted as the image signal DVb. Accordingly, color fringing and resolution degradation in noise removal from the mixing section 235 can be reduced.

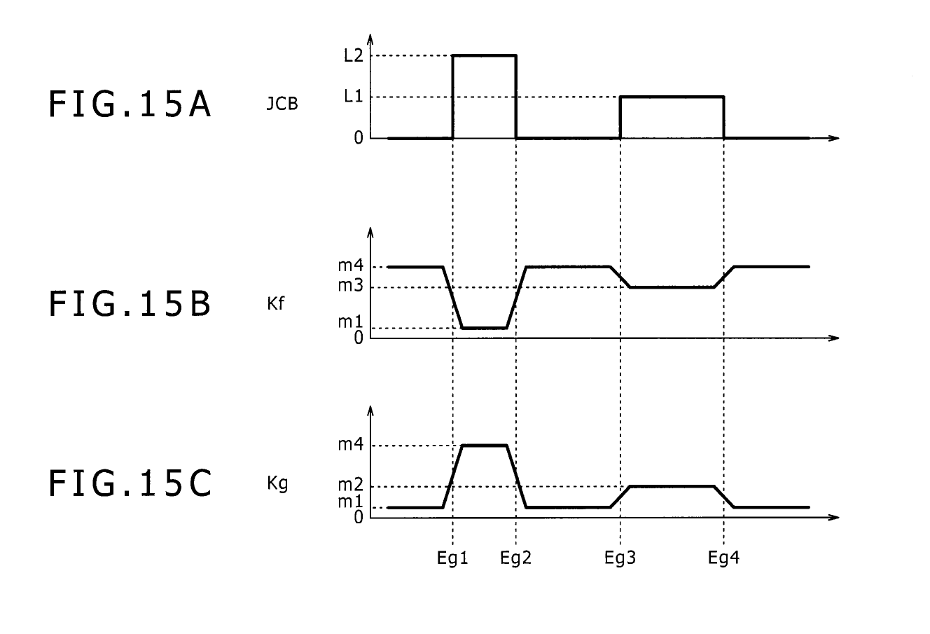

FIGS. 15A to 15C illustrate second operation of the coefficient setting section of the mixing section 235. In the second operation, the mixture ratio between the image signal DVa of the input image and the image signal DF of the smoothed image is varied according to the signal level of the color discrimination signal JCB.

FIG. 15A illustrates the color discrimination signal JCB. FIG. 15B illustrates the coefficient Kf and FIG. 15C illustrates the coefficient Kg.

The mixing section 235 reduces the resolution degradation in a region of a color in which resolution degradation is likely to be perceived by increasing the rate of the image signal DVa based on the color discrimination signal JCB. On the other hand, in a region of a color in which resolution degradation is less likely to be perceived, the mixing section 235 sets the coefficients so as to increase the rate of the image signal DF in order to obtain a noise removing effect.

When the signal level of the color discrimination signal JCB is “0” and does not indicate a region of a color in which resolution degradation is likely to be perceived, the mixing section 235 sets the coefficients Kf=m4 and Kg=m1 (m1<m4). Meanwhile, when the signal level of the color discrimination signal JCB is “L2” and indicates a region of a color in which resolution degradation is likely to be perceived, the mixing section 235 sets the coefficients Kf=m1 and Kg=m4. Further, when the signal level of the color discrimination signal JCB is “L1” and indicates a region of a color in which resolution degradation is less likely to be perceived compared to a region of signal level “L2,” the mixing section 235 sets the coefficients Kf=m3 (m1<m3<m4) and Kg=m2 (m1<m2<m4). Although FIGS. 15A to 15C illustrates a case where m2<m3, the relation of m2 and m3 may be m2=m3 or m2>m3.

If the coefficients Kf and Kg are set as above, since the mixture ratio of the image signal DVa and the image signal DF is adjusted in accordance with the perceivability of resolution degradation, color fringing and resolution degradation in noise removal can be reduced. Further, the variation in noise removing effect can be moderated at portions where the filtering process is switched compared to the first operation.

### <4. Second Mode of the Noise Removing Section>

Next, a second mode of the noise removing section which controls noise removal based on the color discrimination signal JCB and the boundary region signal JA is described.

### <4-1. Configuration and Operation of the Second Mode of the Noise Removing Section>

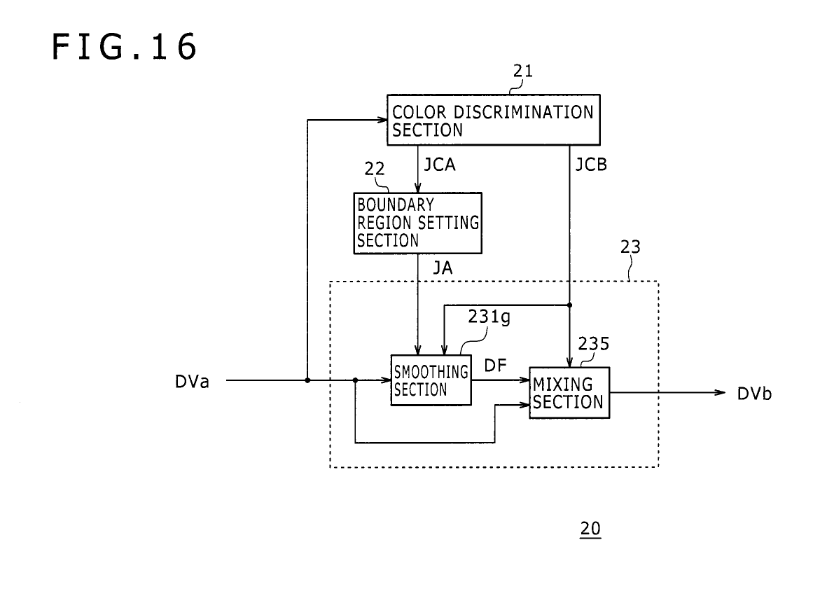

FIG. 16 shows a configuration of a second mode of the noise removing section 23. The noise removing section 23 includes a smoothing section 231g of a fourth configuration and a mixing section 235.

The smoothing section 231g smoothes an input image in order to reduce noise therein. Further, the smoothing section 231g controls the effect of smoothing based on the boundary region signal JA from the boundary region setting section 22 and the color discrimination signal JCB from the color discrimination section 21. The smoothing section 231g outputs an image signal DF of the smoothed image to the mixing section 235.

The mixing section 235 receives the image signal DVa and the image signal DF. The mixing section 235 controls the mixture ratio between the image signal DVa and the image signal DF based on the color discrimination signal JCB supplied from the color discrimination section 21.

In the above described noise removing section of the second configuration, the smoothing section 231g controls the noise removing characteristic based on the boundary region signal JA from the boundary region setting section 22 and the color discrimination signal JCB from the color discrimination section 21 so as to suppress color fringing and resolution degradation in noise removal. The mixing section 235 controls the mixture ratio of the image signal DVa and the image signal DF in accordance with the color discrimination signal JCB from the color discrimination section 21, thereby generating an image signal DVb wherein color fringing and resolution degradation are suppressed and noise is reduced.

### <4-2. Configuration and Operation of the Smoothing Section>

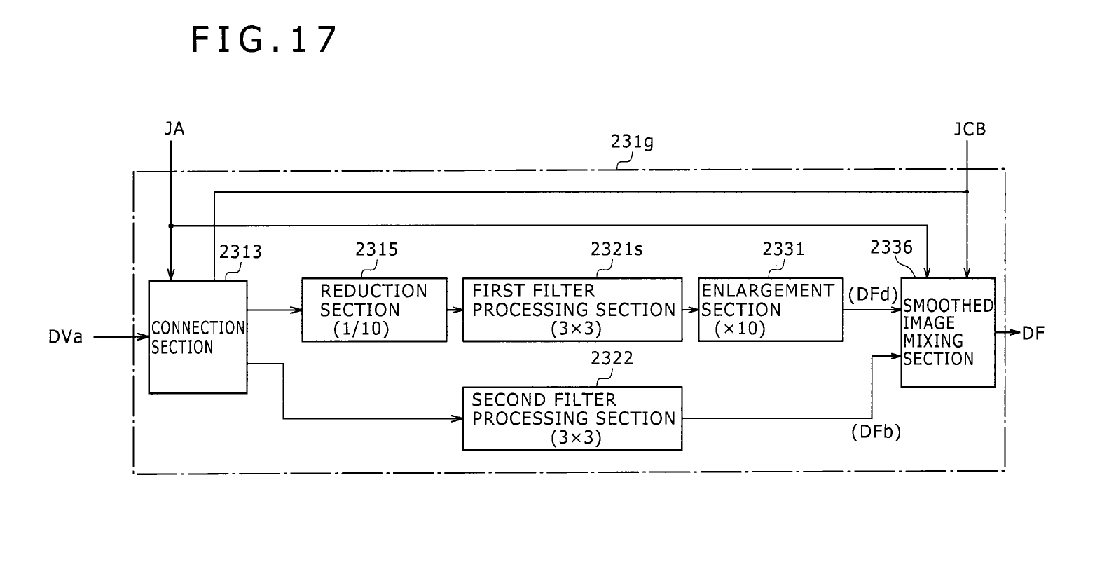

FIG. 17 shows the fourth configuration of the smoothing section. The smoothing section 231g includes a connection section 2313, a reduction section 2315, a second filtering section 2322, a first filtering section 2321s, an enlargement section 2331 and a smoothed image mixing section 2336.

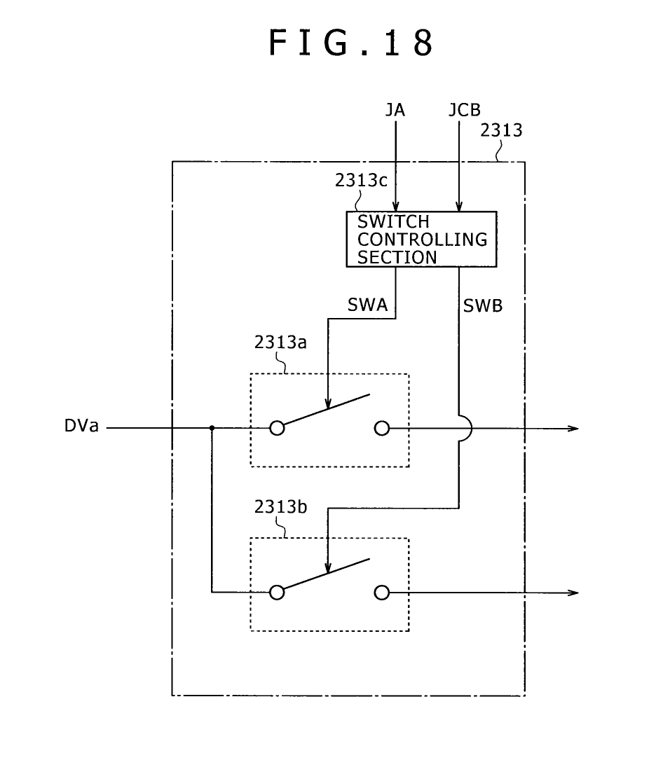

The connection section 2313 controls provision of the image signal DVa of the input image based on the boundary region signal JA and the color discrimination signal JCB. FIG. 18 shows a general configuration of the connection section 2313. The connection section 2313 includes switches 2313a and 2313b and a switch controlling section 2313c. The switch controlling section 2313c produces switch controlling signals SWA and SWB based on the boundary region signal JA and the color discrimination signal JCB to control the switches 2313a and 2313b, thereby controlling provision of the image signal DVa to the reduction section 2315 and the second filtering section 2322.

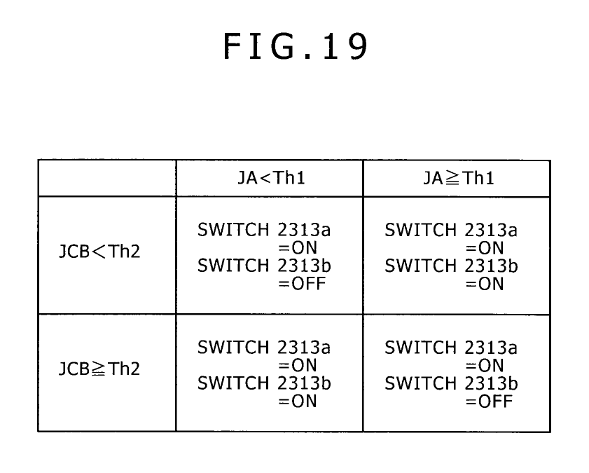

FIG. 19 illustrates the controlling operation of the switch controlling section 2313c. For example, the switch controlling section 2313c compares the boundary region signal JA and the color discrimination signal JCB with respective threshold values. When the signal level of the boundary region signal JA is lower than the threshold value Th1 and the signal level of the color discrimination signal JCB is lower than the threshold value Th2, the switch controlling section 2313c sets only the switch 2313a to the on state. When the signal level of the boundary region signal JA is equal to or higher than the threshold value Th1 and the signal level of the color discrimination signal JCB is equal to or higher than the threshold value Th2, the switch controlling section 2313c sets only the switch 2313a to the on state. When the signal level of the boundary region signal JA is lower than the threshold value Th1 and the signal level of the color discrimination signal JCB is equal to or higher than the threshold value Th2, the switch controlling section 2313c sets both of the switches 2313a and 2313b to the on state. When the signal level of the boundary region signal JA is equal to or higher than the threshold value Th1 and the signal level of the color discrimination signal JCB is lower than the threshold value Th2, the switch controlling section 2313c sets both of the switches 2313a and 2313b to the on state.

In other words, when the signal level of the boundary region signal JA is lower than the threshold value Th1 and the signal level of the color discrimination signal JCB is lower than the threshold value Th2, and when the signal level of the boundary region signal JA is equal to or higher than the threshold value Th1 and the signal level of the color discrimination signal JCB is equal to or higher than the threshold value Th2, the smoothing section 231g carries out smoothing using the first filtering section 2321s. On the other hand, when the signal level of the boundary region signal JA is lower than the threshold value Th1 and the signal level of the color discrimination signal JCB is equal to or higher than the threshold value Th2, and when the signal level of the boundary region signal JA is equal to or higher than the threshold value Th1 and the signal level of the color discrimination signal JCB is lower than the threshold value Th2, the smoothing section 231g carries out smoothing using the second filtering section 2322 and the first filtering section 2321s.

The reduction section 2315 reduces the size of the input image supplied from the connection section 2313, produces an image signal of the reduced image and outputs it to the first filtering section 2321s. For example, if the first filtering section 2321s is to use a signal of 3 pixels×3 pixels to carry out averaging operation and obtain an effect similar to that of smoothing operation using 30 pixels×30 pixels by the first filtering section 2321 in the first configuration, the reduction section 2315 reduces the input image to 1/10.

The first filtering section 2321s is configured to exert a larger smoothing effect compared to the second filtering section 2322 by using the image signal of the reduced image. For example, the first filtering section 2321s carries out averaging operation of 3 pixels×3 pixels using the image signal of the reduced image to obtain an averaging effect similar to that by the first filtering section 2321 in the first configuration. The first filtering section 2321s outputs the produced image signal of the smoothed image to the enlargement section 2331.

The enlargement section 2331 carries out an enlargement process corresponding to the reduction process by the reduction section 2315 and produces an image signal DFd of a smoothed image having an image size or pixel number equal to that before the reduction of the reduction section 2315. The enlargement section 2331 outputs the produced image signal DFd of the smoothed image to the smoothed image mixing section 2336.

As mentioned above, the second filtering section 2322 is configured to be capable of not only noise removal for suppressed color fringing but also noise removal for reduced resolution degradation. For example, as will be demonstrated in other configuration examples of the filtering section described later, the second filtering section 2322 is configured to be capable of switching filters or changing the combination of filters.

When the signal level of the boundary region signal JA is equal to or higher than the threshold value Th1 and the signal level of the color discrimination signal JCB is lower than the threshold value Th2, the second filtering section 2322 carries out noise removal with suppressed color fringing to produce an image signal DFb. On the other hand, when the signal level of the boundary region signal JA is lower than the threshold value Th1 and the signal level of the color discrimination signal JCB is equal to or higher than the threshold value Th2, the second filtering section 2322 carries out noise removal with reduced resolution degradation to produce an image signal DFb.

The smoothed image mixing section 2336 uses the coefficients Kd and Ke determined based on the result of comparison between the boundary region signal JA and the threshold value Th1 and coefficients Kh and Kj determined based on the result of comparison between the color discrimination signal JCB and the threshold value Th2 to adjust the signal levels of the image signals of the smoothed images and adds them. The expression (3) below represents the arithmetic processing carried out by the smoothed image mixing section 2336.

DF=Kd×Kh×DFb+Ke×Kj×DFd (3)

Incidentally, the coefficients can be set similarly to the setting of the coefficients based on the boundary region signal and the setting of the coefficients based on the color discrimination signal described earlier.

Configuring the noise removing section as described above, since a smoothed image signal which takes into consideration resolution degradation can be produced by the smoothing section, reduction of color fringing and resolution degradation in noise removal can be optimized better compared to the first mode. Further, if noise removal with suppressed resolution degradation is carried out in the smoothing section 231g, it is also possible to omit the mixture of the image signal DVa of the input image in the mixing section 235.

### <5. Other Configurations of the Filtering Section>

Incidentally, while the filtering section of the smoothing section described so far carries out a predetermined smoothing process for an inputted image signal, if the filtering section is configured to have switchable processing characteristics, even more optimum noise removal can be realized.

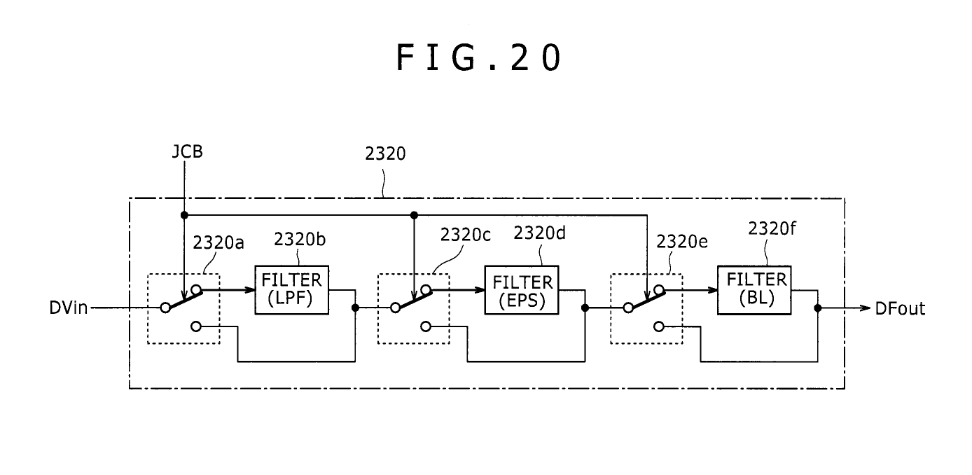

FIG. 20 illustrates a configuration example of a filtering section provided with switchable processing characteristics. The filtering section 2320 includes three signal selection sections 2320a, 2320c and 2320e and three filters 2320b, 2320d and 2320f. The filters 2320b, 2320d and 2320f are, for example, neighboring pixel averaging filters.

The signal selection section 2320a outputs an inputted image signal DVin to one of the filter 2320b and the signal selection section 2320c.

The filter 2320b is, for example, a simple low-pass filter (LPF). The filter 2320b filters the image signal supplied from the signal selection section 2320a and outputs the filtered image signal to the signal selection section 2320c.

The signal selection section 2320c outputs the image signal supplied from the signal selection section 2320a or the filtered image signal supplied from the filter 2320b to one of the filter 2320d and the signal selection section 2320e.

The filter 2320d is, for example, an epsilon filter (EPS) which has a higher noise removing performance than that of simple low-pass filters (LPF). The filter 2320d filters the image signal supplied from the signal selection section 2320c and outputs the filtered image signal to the signal selection section 2320e.

The signal selection section 2320e outputs the image signal supplied from the signal selection section 2320c or the filtered image signal supplied from the filter 2320d to the filter 2320f or outputs it as an image signal DFout of the smoothed image.

The filter 2320f is, for example, a bilateral filter (BL) which has a higher noise removing performance than that of epsilon filters (EPS). The filter 2320f filters the image signal supplied from the signal selection section 2320e and outputs the filtered image signal as the image signal DFout of the smoothed image.

The filtering section 2320 configured as above controls signal selection operations of the signal selection sections 2320a, 2320c and 2320e based on the boundary region signal JA and the color discrimination signal JCB, thereby selecting the filter for processing the image signal. For example, for a region in which resolution degradation is likely to be perceived, the filtering section 2320 controls the signal selection operations of the signal selection sections 2320a, 2320c and 2320e so that the processing is carried out using a filter which causes comparatively little resolution degradation. On the other hand, for a region in which color fringing is likely to be perceived, the filtering section 2320 controls the signal selection operations of the signal selection sections 2320a, 2320c and 2320e so that the processing is carried out using a filter which causes comparatively little color fringing.

Configuring the filtering section 2320 as described above, it is possible to perform noise removal optimum for boundary regions in which color fringing is likely to be perceived or regions of colors in which resolution degradation is likely to be perceived.

Further, if such a filtering section 2320 is employed as the second filtering section 2322 of the smoothing section shown in FIG. 17, the processing can be optimized by switching the filter or changing the combination of the filters to be used based on the boundary region signal JA and the color discrimination signal JCB. For example, when the signal level of the boundary region signal JA is lower than the threshold value Th1 and the signal level of the color discrimination signal JCB is equal to or higher than the threshold value Th2, the second filtering section 2322 judges that the region is a region of a color in which resolution degradation is likely to be perceived, and carries out the processing by selecting a filter or a combination of filters that cause comparatively little resolution degradation as described above. On the other hand, when the signal level of the boundary region signal JA is equal to or higher than the threshold value Th1 and the signal level of the color discrimination signal JCB is lower than the threshold value Th2, the second filtering section 2322 judges that the region is a boundary region of a color in which color fringing is likely to be perceived, and carries out the processing by selecting a filter or a combination of filters that cause comparatively little color fringing as described above. Altering the configuration as such, the second filtering section 2322 can carry out optimum noise removal not only for a boundary region of a color in which color fringing is likely to be perceived but also a region of a color in which resolution degradation is likely to be perceived. Alternatively, the filtering section 2320 may be used as the first filtering section 2321s in the smoothing section of the fourth configuration shown in FIG. 17, so that the filter or combination of filters to be used are changed based on the boundary region signal JA and the color discrimination signal JCB.

### <6. Other Modes of the Noise Removal Processing Section>

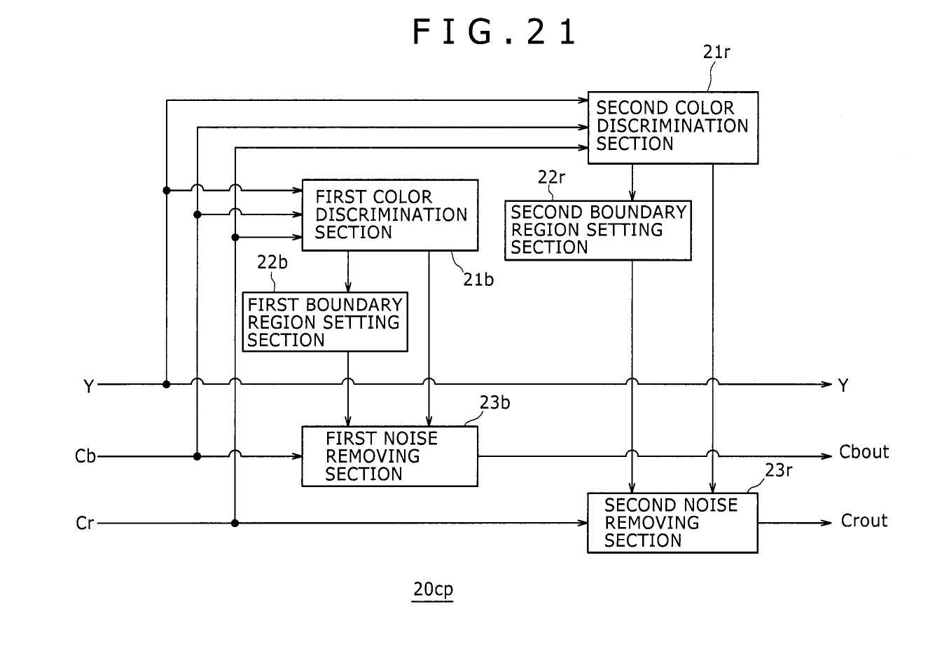

Next, as another mode of the noise removal processing section, a mode in which the image signal of the input image is component signals, for example, a case where the signal conversion section 14 shown in FIG. 1 provides a luminance signal Y and color difference signals Cb and Cr is described. FIG. 21 illustrates a configuration example of a noise removal processing section that uses component signals.

The noise removal processing section 20cp includes a first color discrimination section 21b and second color discrimination section 21r, a first boundary region setting section 22b and second boundary region setting section 22r, and a first noise removing section 23b and second noise removing section 23r.

The luminance signal Y is supplied to the first color discrimination section 21b and the second color discrimination section 21r. The blue color difference signal Cb is supplied to the first color discrimination section 21b, the second color discrimination section 21r and the first noise removing section 23b. The red color difference signal Cr is supplied to the first color discrimination section 21b, the second color discrimination section 21r and the second noise removing section 23r.

The first color discrimination section 21b carries out color discrimination based on the luminance signal Y and the color difference signals Cb and Cr and carries out discrimination of a color in which color fringing or resolution degradation is likely to be perceived in a color space related to the blue color difference signal. Further, the first color discrimination section 21b produces color discrimination signals indicating the results of the color discrimination and outputs them to the first boundary region setting section 22b and the first noise removing section 23b.

The first boundary region setting section 22b sets a boundary region indicative of the boundary of a color in which color fringing is likely to be perceived in a color space related to the blue color difference signal based on the color discrimination signal similarly to the boundary region setting section 22 described above. The first boundary region setting section 22b outputs the set boundary region signal to the first noise removing section 23b.

The first noise removing section 23b controls, for example, the switching of filtering processes and the mixture ratio of the filtered color difference signals based on the boundary region signal and the color discrimination signal, thereby removing noise from the blue color difference signal Cb. The noise-removed signal is outputted as a blue color difference signal Cbout.

The second color discrimination section 21r carries out color discrimination based on the luminance signal Y and the color difference signals Cb and Cr to carry out discrimination of a color in which color fringing or resolution degradation is likely to be perceived in a color space related to a red color difference signal. Further, the second color discrimination section 21r produces color discrimination signals indicative of the results of the color discrimination and outputs them to the second boundary region setting section 22r and the second noise removing section 23r.

The second boundary region setting section 22r sets a boundary region indicative of the boundary of a color in which color fringing is likely to be perceived in a color space related to the red color difference signal based on the color discrimination signal similarly to the boundary region setting section 22 described earlier. The set boundary region signal is outputted to the second noise removing section 23r.

The second noise removing section 23r controls, for example, the switching of filtering processes and the mixture ratio of the filtered color difference signals based on the boundary region signal and the color discrimination signal, thereby removing noise from the red color difference signal Cr. The noise-removed red color difference signal is outputted as a red color difference signal Crout.

It is to be noted that the first color discrimination section 21b and the second color discrimination signal 21r carry out color discrimination based on the luminance signal Y and the color difference signals Cb and Cr. Accordingly, color discrimination can be carried out with higher accuracy compared to a case in which, for example, the first color discrimination section 21b carries out color discrimination using the blue color difference signal Cb and the second color discrimination section 21r carries out color discrimination using the red color difference signal Cr.

Carrying out color discrimination in color spaces of a plurality of dimensions, and removing noise for each color space in this manner, noise removal can be controlled more finely. Accordingly, a high picture quality can be achieved compared to the first mode. Further, since noise removal is carried out for each color space, the process time can be reduced compared to the first mode. In this mode described above, a luminance signal and color difference signals are used as input image signals. If the input image signals are, for example, three primary color signals, noise removal is carried out similarly for each color signal.

The series of processes described herein can be executed by hardware, software or a composite configuration of hardware and software. When the processes are to be executed by software, it is executed by installing a program in which the processing sequence is recorded into a memory in a computer incorporated in dedicated hardware. Alternatively, it is also possible to execute the program by installing it into a general-purpose computer that can execute various processes.

For example, the program can be recorded in advance on a hard disk or in a ROM (Read Only Memory) as a recording medium. The program may also be stored or recorded temporarily or permanently on or in a removable recording medium such as a flexible disk, a CD-ROM (Compact Disc Read Only Memory), an MO (Magneto-Optical) disk, a DVD (Digital Versatile Disc), a magnetic disk or a semiconductor memory card. Such a removable recording medium can be provided as package software.

Alternatively, other than installing the program into a computer from a removable recording medium, it may be transferred from a download site to a computer by wireless or wire transmission through a network such as a LAN (Local Area Network) or the Internet. The computer can receive the transferred program and install it into a recording medium such as a built-in hard disk.

It is to be noted that the present technology shall not be interpreted restrictively to the embodiment of the present technology described above. The filters, the pixel numbers and image reduction ratios used in the filter calculation, and other elements and factors used in this embodiment are mere examples, and it is apparent that a person skilled in the art can make various modifications, combinations, sub-combinations and alterations without departing from the spirit and scope of the present technology. The spirit and scope of the present technology should be determined according to the claims.

Image processing apparatuses according to embodiments of the present technology may also take such configurations as described below.

(1) An image processing apparatus, including:

a color discrimination section configured to discriminate a color of each pixel of an input image;

a boundary region setting section configured to set a boundary region of a predetermined color based on a result of the color discrimination in the color discrimination section; and

a noise removing section configured to control a noise removing characteristic based on a result of the boundary region setting in the boundary region setting section to remove noise from the input image.

(2) The image processing apparatus according to (1), wherein

the noise removing section includes a smoothing section configured to smooth the input image and produce a smoothed image; and

the smoothing section controls the noise removing characteristic by carrying out, in the boundary region, a smoothing process in which a smoothing unit is narrow compared to that for a non-boundary region based on the result of the boundary region setting.

(3) The image processing apparatus according to (2), wherein

the smoothing section includes
a first filtering section configured to smooth an image in the non-boundary region, and
a second filtering section configured to smooth an image in the boundary region.

(4) The image processing apparatus according to (3), wherein

the smoothing section includes
a reduction section configured to reduce the image in the non-boundary region and supply the reduced image to the first filtering section, and
an enlargement section configured to return the size of the reduced image to the size before the reduction after the reduced image has been smoothed in the first filtering section.

(5) The image processing apparatus according to (4), wherein

the smoothing section further includes a smoothed image mixing section configured to mix a first smoothed image returned to the size thereof before the reduction in the enlargement section and a second smoothed image produced in the second filtering section based on the result of the boundary region setting;

the reduction section reduces the images in the non-boundary region and the boundary region; and

the smoothed image mixing section changes, based on the result of the boundary region setting, the noise removing characteristic by controlling a mixture ratio between the first and second smoothed images.

(6) The image processing apparatus according to (5), wherein the smoothed image mixing section mixes the smoothed images such that the rate of the second smoothed image is higher in the boundary region than that in the non-boundary region.

(7) The image processing apparatus according to any one of (3) to (6), wherein at least one of the first filtering section and the second filtering section in the smoothing section is composed of a plurality of filters having different characteristics, and switching of the filters or changing of the combination of the filters is carried out based on a result of the color discrimination.

(8) The image processing apparatus according to (7), wherein the smoothing section, based on the result of the color discrimination, switches the filter or combination to a filter or combination with which resolution degradation is less likely to occur in a region of a color in which resolution degradation is likely to be perceived.

(9) The image processing apparatus according to any one of (1) to (8), wherein

the noise removing section includes
a smoothing section configured to smooth the input image and produce a smoothed image, and
a mixing section configured to control a mixture ratio between the input image and the smoothed image produced in the smoothing section to change the noise removing characteristic.

(10) The image processing apparatus according to (9), wherein the mixing section mixes the input image and the smoothed image such that a rate of the input image is higher in a region of a predetermined color than that in a region of a color different from the predetermined color based on a result of the color discrimination by the color discrimination section.

In an image processing apparatus, image processing method and program according to embodiments of the present technology, the color of each pixel of an input image is discriminated, and a boundary region of a predetermined color is set based on a result of the color discrimination. The noise removing characteristic is controlled based on the result of the boundary region setting, and noise removal of the input image is carried out accordingly. Therefore, by switching the noise removing characteristic on the boundary of a color in which color fringing is likely to be perceived, a noise-removed image in which color fringing upon noise removal is suppressed can be obtained. Accordingly, the present technology is suitable for electronic devices that have an image pickup function, editing devices and computers that perform editing and processing of images, and so on.

The present disclosure contains subject matter related to that disclosed in Japanese Priority Patent Application JP 2011-244704 filed in the Japan Patent Office on Nov. 8, 2011, the entire content of which is hereby incorporated by reference.

What is claimed is:

1. An image processing apparatus, comprising:
a color discrimination section configured to discriminate a color of each pixel of an input image;
a boundary region setting section configured to set a boundary region of a predetermined color based on a result of the color discrimination in the color discrimination section; and
a noise removing section configured to control a noise removing characteristic based on a result of the boundary region setting in the boundary region setting section to remove noise from the input image.

2. The image processing apparatus according to claim 1, wherein
the noise removing section includes a smoothing section configured to smooth the input image and produce a smoothed image; and
the smoothing section controls the noise removing characteristic by carrying out, in the boundary region, a smoothing process in which a smoothing unit is narrow compared to that for a non-boundary region based on the result of the boundary region setting.

3. The image processing apparatus according to claim 2, wherein
the smoothing section includes
a first filtering section configured to smooth an image in the non-boundary region, and
a second filtering section configured to smooth an image in the boundary region.

4. The image processing apparatus according to claim 3, wherein
the smoothing section includes
a reduction section configured to reduce the image in the non-boundary region and supply the reduced image to the first filtering section, and
an enlargement section configured to return the size of the reduced image to the size before the reduction after the reduced image has been smoothed in the first filtering section.

5. The image processing apparatus according to claim 4, wherein
the smoothing section further includes a smoothed image mixing section configured to mix a first smoothed image returned to the size thereof before the reduction in the enlargement section and a second smoothed image produced in the second filtering section based on the result of the boundary region setting;
the reduction section reduces the images in the non-boundary region and the boundary region; and
the smoothed image mixing section changes, based on the result of the boundary region setting, the noise removing characteristic by controlling a mixture ratio between the first and second smoothed images.

6. The image processing apparatus according to claim 5, wherein the smoothed image mixing section mixes the smoothed images such that the rate of the second smoothed image is higher in the boundary region than that in the non-boundary region.

7. The image processing apparatus according to claim 3, wherein at least one of the first filtering section and the second filtering section in the smoothing section is composed of a plurality of filters having different characteristics, and switching of the filters or changing of the combination of the filters is carried out based on a result of the color discrimination.

8. The image processing apparatus according to claim 7, wherein the smoothing section, based on the result of the color discrimination, switches the filter or combination to a filter or combination with which resolution degradation is less likely to occur in a region of a color in which resolution degradation is likely to be perceived.

9. The image processing apparatus according to claim 1, wherein
the noise removing section includes
a smoothing section configured to smooth the input image and produce a smoothed image, and
a mixing section configured to control a mixture ratio between the input image and the smoothed image produced in the smoothing section to change the noise removing characteristic.

10. The image processing apparatus according to claim 9, wherein the mixing section mixes the input image and the smoothed image such that a rate of the input image is higher in a region of a predetermined color than that in a region of a color different from the predetermined color based on a result of the color discrimination by the color discrimination section.

11. An image processing method, comprising:
discriminating a color of each pixel of an input image;
setting a boundary region of a predetermined color based on a result of the color discrimination; and
controlling a noise removing characteristic based on a result of the boundary region setting to remove noise from the input image.

12. A program that allows a computer to execute noise removal of an input image, comprising:
discriminating a color of each pixel of the input image;
setting a boundary region of a predetermined color based on a result of the color discrimination; and
controlling a noise removing characteristic based on a result of the boundary region setting to remove noise from the input image.
